(19) United States
(12) Patent Application Publication
(10) Pub. No.: US 2019/0134683 A1
(43) Pub. Date: May 9, 2019

(54) Safety Cabinet and Isolator

(71) Applicant: Hitachi Industrial Equipment Systems Co., Ltd., Chiyoda-ku, Tokyo (JP)

(72) Inventors: Keiichi ONO, Tainai (JP); Masashi TAKASAWA, Tokyo (JP)

(21) Appl. No.: 16/099,885

(22) PCT Filed: Feb. 15, 2017
(86) PCT No.: PCT/JP2017/005411

§ 371 Date: Nov. 8, 2018

(30) Foreign Application Priority Data
May 26, 2016 (JP) 2016-105483

(51) Int. Cl. B08B 15/02; B01L 1/04

(52) U.S. Cl. CPC B08B 15/023; B01L 1/04; B08B 2215/003; B01L 2200/082; B01L 2300/0681

(57) ABSTRACT

Provided is a safety cabinet that, when multiple different kinds of pathogens or the like are handled in the same safety cabinet, can prevent previously-handled pathogens or the like from being commingled with pathogens or the like to be subsequently handled after cleaning and disinfection. The safety cabinet includes a work opening in the front face of a work space and supplies clean air to the work space from above, wherein the safety cabinet is provided with the following: a rear air inlet formed in the back surface lower part or in the bottom rear side of the work space; a front air inlet formed in the bottom front side of the work space; and a work table air inlet formed in a work surface, between the rear air inlet and the front air inlet, and parallel to the front air inlet and/or the rear air inlet.

### TECHNICAL FIELD

The present invention relates to a safety cabinet and an isolator or the like to handle a plurality of kinds of pathogens or the like inside equipment with usage for study of pathogens or the like, germfree medical goods, biological medial goods, regeneration medicine, etc.

### BACKGROUND ART

When handling tissues which may be infected with a pathogen or the like in study of pathogens or the like and regeneration medicine, a safety cabinet (Class II Cabinet for biohazard countermeasures), an isolator, and a glove box are used. A patient's tissue may be infected with an infective disease in regeneration medicine or the like. In order to avoid transmission of a pathogen or the like causing the infective disease to a patient's tissue to be treated subsequently, it is required to clean and disinfect the inside or a work space and place it in a germfree state before changing the patient's tissue to be handled. In addition, for study, pathogens or the like are handled inside a safety cabinet. Pathogens or the like refer to viruses, bacteria, true fungi, etc. and they have specific properties; in some cases, one pathogen or the like may have an effect on another pathogen or the like. When changing between kinds of pathogens or the like to be handled in a single safety cabinet, it is required to clean and disinfect the inside of the work space.

As background art in the present technical field, there is PTL 1. This PTL 1 discloses a safety cabinet which is provided with an air feeding HEPA filter above a work space, an openable/closable front door in a front side of the work space, a back side intake part on a back side wall, and a front side intake part at bottom front. Air is supplied into the work space evenly through the air feeding HEPA filter and air is drawn through the front side intake part and the back side intake part of a work table that defines the bottom surface of the work space. Thereby, cleaning is performed with air that falls evenly from top to bottom.

### CITATION LIST

### Patent Literature

PTL 1: Japanese Patent Application Laid-Open No. 2002-79117

### SUMMARY OF INVENTION

### Technical Problem

By using an airflow in the safety cabinet disclosed in PTL 1, it is possible to prevent a pathogen or the like from diffusing in a wide range in the work space of the safety cabinet along with handling a pathogen or the like inside the work space and it is also possible to prevent a pathogen or the like from leaking out to an operator side from the inside of the work space. When handing different kinds of pathogens or the like with a single safety cabinet, cleaning and disinfecting the inside of the work space are carried out when handing of a pathogen or the like finishes to avoid that a previously handled pathogen or the like gets mixed into a pathogen or the like to be treated subsequently. However, in a case where cleaning and disinfecting the inside of the work space cannot be accomplished sufficiently and a pathogen or the like remains on the working surface, it is impossible to eliminate the possibility that different kinds of pathogens or the like get mixed with one another.

The present invention is intended to provide a safety cabinet that enables it to prevent that a previously handled pathogen or the like gets mixed into a pathogen or the like to be subsequently handled after cleaning and disinfection, when handing a plurality of kinds of pathogens or the like inside a single safety cabinet.

### Solution to Problem

To solve the above problem, one example of a “safety cabinet” of the present invention is as follows: a safety cabinet having a work opening in a front side of a work space and supplying clean air to the work space from above, the safety cabinet including a rear air inlet formed in a rear lower part of or at bottom rear side of the work space; a front air inlet formed at bottom front side of the work space; and a work table air inlet formed in a working surface between the rear air inlet and the front air inlet and in parallel to the front air inlet and/or the rear air inlet.

In addition, one example of an isolator of the present invention is as follows: an isolator having a glove or gloves in one side or both sides of surfaces to face each other of a work space and supplying clean air to the work space from above, the isolator including a working surface formed at the bottom of the work space; intake holes formed on both sides of the working surface; and an air inlet formed in the working surface between the intake holes on the both sides and in parallel to the intake holes.

### Advantageous Effects of Invention

According to the present invention, it is possible to prevent that a previously handled pathogen or the like gets mixed into a pathogen or the like to be subsequently handled after cleaning and disinfection, when handing a plurality of kinds of pathogens or the like inside a single safety cabinet.

### BRIEF DESCRIPTION OF DRAWINGS

FIG. 1A is an example of a cross-sectional structure diagram depicting a safety cabinet of Example 1 of the present invention.

FIG. 1B is an example of an external front view depicting the safety cabinet of Example 1 of the present invention.

FIG. 1C is an example of a plan view of a work table depicting the safety cabinet of Example 1 of the present invention.

FIG. 2A is an example of a cross-sectional structure diagram depicting a safety cabinet of Example 2 of the present invention.

FIG. 2B is an example of an external front view depicting the safety cabinet of Example 2 of the present invention.

FIG. 2C is an example of a plan view of a work table depicting the safety cabinet of Example 2 of the present invention.

FIG. 3A is an example of a cross-sectional structure diagram depicting a safety cabinet of Example 3 of the present invention.

FIG. 3B is an example of an external front view depicting the safety cabinet of Example 3 of the present invention.

FIG. 3C is an example of a plan view of a work table depicting the safety cabinet of Example 3 of the present invention.

FIG. 4A is an example of a cross-sectional structure diagram depicting a safety cabinet of Example 4 of the present invention.

FIG. 4B is an example of a plan view of a work table depicting the safety cabinet of Example 4 of the present invention.

FIG. 4C is a modification example of a cross-sectional structure diagram depicting the safety cabinet of Example 4 of the present invention.

FIG. 4D is a modification example of a plan view of a work table depicting the safety cabinet of Example 4 of the present invention.

FIG. 5A is an example of a cross-sectional structure diagram depicting an isolator of Example 5 of the present invention.

FIG. 5B is an example of an external front view depicting the isolator of Example 5 of the present invention.

FIG. 5C is an example of a plan view of a work table depicting the isolator of Example 5 of the present invention.

FIG. 6A is an example of a side cross-sectional structure diagram depicting the isolator of Example 5 of the present invention.

FIG. 6B is an example of a cross-sectional front view depicting the isolator of Example 5 of the present invention.

### DESCRIPTION OF EMBODIMENTS

In the following, embodiment examples of the present invention are described with the aid of the drawings. Now, in the respective drawings for explaining the embodiment examples, identical components are identically names and assigned identical reference numerals and their duplicated description is omitted.

### Example 1

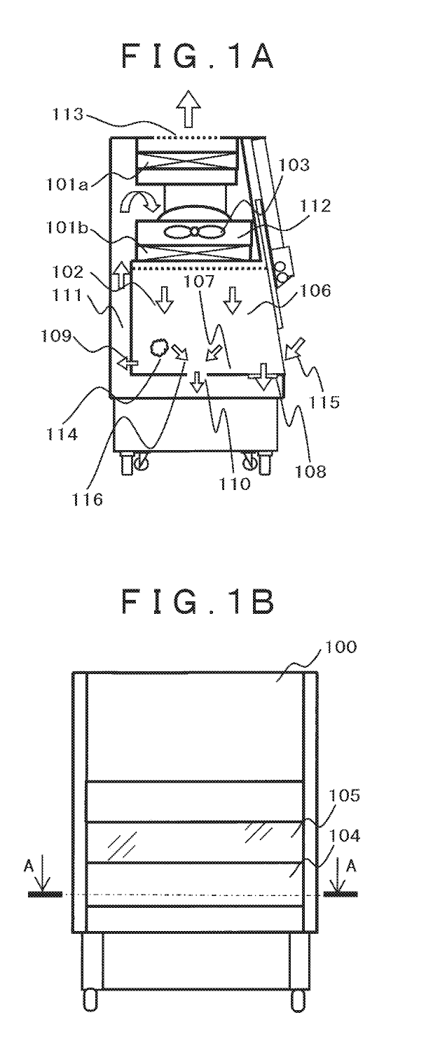

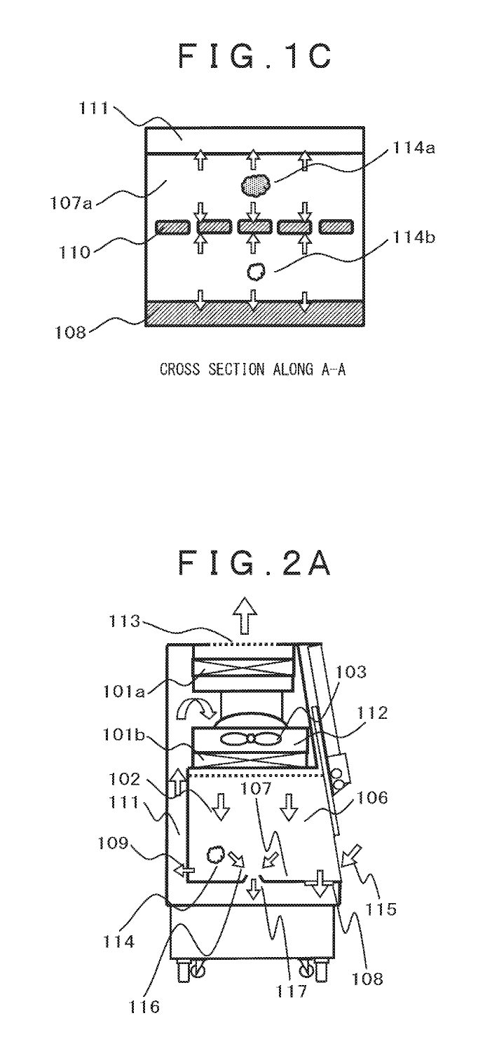

FIG. 1A is a cross-sectional structure diagram depicting a safety cabinet of Example 1, FIG. 1B is an external front view depicting the safety cabinet of Example 1, and FIG. 1C is a plan view of a work table (a cross-sectional view along line A-A in FIG. 1B) depicting the safety cabinet of Example 1.

An influent airflow 115 which has been drawn in through a work opening 104 is drawn into a work table front air inlet 108. The drawn-in air flows under a work table 107 and through a rear flow path 111 in sequence and is drawn into an air blower 103. The air blower 103 pressurizes a pressure chamber 112. To the pressure chamber 112, an exhaust HEPA filter 101a and a blowing HEPA filter 101b are connected. Because the pressure chamber 112 is pressurized, one part of air inside the pressure chamber 112 is filtered by the blowing HEPA filter 101b to filter out dust including pathogens or the like and supplied as clean air 102 to a work space 106. Air inside the work space 106 is drawn forward into the work table front air inlet 108 and drawn rearward into a rear air inlet 109, passes through the rear flow path 111 and is drawn into the air blower 103 again. Now, although the rear air inlet 109 is formed in a rear lower part of the work space, as in FIG. 1A, it may be formed at bottom rear side of the work space.

Because the exhaust HEPA filter 101a is also connected to the pressure chamber 112, the other part of air inside the pressure chamber 112 is filtered by the exhaust HEPA filter 101a to filter out dust including pathogens or the like and discharged from an exhaust outlet 113. Opening portions through which air move in and out of the safety cabinet 100 are only the exhaust outlet 113 and the work opening 104 and, therefore, the amount of air discharged from the exhaust outlet 113 is equal to the amount of air entering the cabinet through the work opening 104. This airflow arrangement is type A1 and type A2, as classified by air flow arrangement according to JIS K3800, a standard for safety cabinets (official name: Class II Cabinet for biohazard countermeasures). This standard includes type B2 of which the airflow arrangement is as follows: air drawn in through the work opening 104 flows through the work table front air inlet 108, passes under the work table 107 and through the rear flow path 111, and the air is filtered by the exhaust HEPA filter 101a to filter out dust including pathogens or the like and discharged from the safety cabinet 100. Air outside of the safety cabinet 100 is supplied to the pressure chamber 112 and the air is filtered by the blowing HEPA filter to filter out dust and supplied as clean air 102 to the work space 106. Air in the work space 106 is drawn into the rear air inlet 109 and the work table front air inlet 108 and discharged from the safety cabinet 100. The airflow arrangement as to the inside of the work space 106, the work opening 104, the work table front air inlet 108, and the rear air inlet 109 is the same for types A1, A2, and B2.

When an experiment is carried out inside the work space 106 of the safety cabinet 100, the inside of the work space 106 is visible through a glass area of a front shutter 105.

The safety cabinet 100 prevents a pathogen or the like 114 that is handled inside the work space 106 from leaking out of the safety cabinet 100, attributed to the influent airflow 115 through the work opening 104. Additionally, both clean air 102 blowing into the work space 106 and the influent airflow 115 are drawn into the work table front air inlet 108 and this serves to shield the work space 106 from outside of the safety cabinet 100 and keeps the work space 106 in a germfree, clean state. Moreover, the blowing HEPA filter 101b, the working opening 104, the work table front air inlet 108, and the rear air inlet 109 are formed to have a uniform shape in a lateral direction of the safety cabinet 100; this enables it to make the same airflow anywhere in the cross section depicted in FIG. 1A and minimizes moving of air in the lateral direction of the work space 106. This function of minimizing moving of an experimental material such as a pathogen or the like 114 by the airflow is termed as inter-sample contamination prevention.

In Example 1, the work table air inlet 110 is formed in the work table 107. The work table air inlet 110 is provided in a substantially intermediate position between the rear air inlet 109 and the work table front air inlet 108. As depicted in FIG. 1C, the work table air inlet 110 is provided in parallel to the rear air inlet 109 and the work table front air inlet 108, e.g., in parallel to a safety cabinet's front surface that an operator faces toward. A drawn-in airflow 116 into the work space 106 is formed by the work table air inlet 110. The drawn-in airflow 116 flows under the work table 107, passes through the rear flow path 111, and is drawn into the air blower 103. A pathogen or the like 114 that is included in the drawn-in airflow 116 is also drawn into the air blower 103 and trapped by the exhaust HEPA filter 101a and the blowing HEPA filter 101b.

When pathogens or the like 114 are handled with a conventional safety cabinet 100 without the work table air inlet 110, a pathogen or the like 114 is handled in the vicinity of the center of the work table 107. Because clean air 102 is supplied into the work space 106, an experiment can be carried out in a condition that is free from germs and dust other than the pathogen or the like 114 to be treated. An experiment is carried out with the operator's arms being inserted into the work space 106 through the work opening 104. Moving the arms into and out of the work space through the work opening 104 brings about the possibility that the pathogen or the like 114 is brought out of the safety cabinet 100 by an airflow that is generated when doing so. Therefore, experimental tools are placed temporarily on the work table 107 inside the work space 106. When placing the tools temporarily, they are arranged in a lateral direction, right or left, with respect to a spot where the pathogen or the like 114 is to be treated. Clean air 102 is also supplied to a location where the tools were placed temporarily. Lateral direction movement of the airflow inside the work space 106 of the safety cabinet 100 is minimized. The spot where an experiment will be carried out and the location where the tools are placed temporarily are lined up in a lateral direction; this makes it possible to eliminate the possibility that dust attached to the tools mixes with a pathogen or the like 114 subjected to an experiment and the possibility that the pathogen or the like 114 subjected to an experiment attaches to the temporality placed tools.

In addition, when pathogens or the like 114 are handled in an experiment with a conventional safety cabinet 100 without the work table air inlet 110, unwanted wastes arise during the experiment. When the operator withdraws his or her arms out through the work opening 104 to remove the wastes from the work space 106, this action brings about the possibility that a pathogen or the like 114 is brought out of the safety cabinet 100 at the same time by an airflow that is generated. Therefore, a container such as a can is placed on the work table 107 to put unwanted wastes into it temporarily and remove them after the experiment finishes. When putting the wastes into the waste container, germs and dust that are unwanted for the experiment may fly and come into the container. To keep these germs away from the space where an experiment is carried out, the waster container into which the wasters are put temporarily is placed in a position that is nearer to the rear air inlet 109 in an anteroposterior direction, relative to the center of the work table 107. By thus placing the container, clean air 102 is supplied to the container from above and germs and dust that may be generated when the wastes are put into the container temporality are expelled far from the vicinity of the center of the space where an experiment is carried out and drawn into the rear air inlet 109; thus, the space where an experiment is carried out is kept clean.

When different kinds of pathogens or the like 114 are treated with a single conventional safety cabinet 100, the inside of the work space 106 is cleaned and disinfected when handling of a pathogen or the like 114a finishes to avoid that the previously handled pathogen or the like 114a gets mixed into a pathogen or the like 114b to be subsequently handled. Because clean air 102 is supplied into the work space 106, it is not supposed that different kinds of pathogens or the like 114 get mixed with one another via the supplied air. Such mixing may occur in a case where cleaning and disinfection cannot be accomplished sufficiently and the pathogen or the like 114a remains on the working surface 107a. The case where cleaning and disinfection cannot be accomplished sufficiently is, inter alia, a case where, during wiping for cleaning, a clearance is made between a cleaning wiper and the working surface 107a and the pathogen or the like 114a could not be wiped off or a case where a type of chemicals for use for cleaning and disinfection is not suitable for killing the pathogen or the like 114a. When different kinds of pathogens or the like 114 are treated with a single safety cabinet 100, it is important to eliminate the possibility that a pathogen or the like 114a that could not be killed and removed effectively encounters a pathogen or the like 114b to be subsequently handled.

A method for usage of Example 1 is described with FIG. 1C. Handle a pathogen or the like 114a on the working surface 107a. In the center of the working surface 107a, the work table air inlet 110 is formed. Handle the pathogen or the like 114a on the working surface 107a that is nearer to the rear air inlet 109 than the work table air inlet 110. Because an airflow above the working surface 107a is drawn into the rear air inlet 109 and the work table air inlet 110, there is a less possibility that the pathogen or the like 114a scatters and falls on a portion of the working surface 107a that is nearer to the work table front air inlet 108, passing across the work table air inlet 110. In case the pathogen or the like should come, passing across the work table air inlet 110, it is drawn into the work table front air inlet 108 and, therefore, does not leak out of the safety cabinet 100. After the handling of the pathogen or the like 114a finishes, clean and disinfect the inner surfaces of the work space 106 including the working surface 107a with a suitable disinfectant. Since there is a less possibility that the pathogen or the like 114a initially exists in the portion of the working surface 107a nearer to the work table front air inlet 108 than the work table air inlet 110, cleaning and disinfection over the working surface 107a eliminate the possibility that the pathogen or the like 114a exists on the surface nearer to the work table front air inlet 108 than the work table air inlet 110.

When a pathogen or the like 114b is treated subsequently, treat it in a space that is nearer to the work table front air inlet 108 than the work table air inlet 110 on the working surface 107a. Even in handling the pathogen or the like 114b on the work surface 107 in the near side of the work table air inlet 110, there is no possibility that pathogen or the like 114b leaks out to the operator side, because an influent airflow 115 generated by the work table front air inlet 108 is present between the pathogen or the like 114b and the experiment operator. In FIG. 1C, a portion of the working surface 107a where the pathogen or the like 114b is treated differs from a portion of the working surface 107a where the pathogen or the like 114 was treated; this rules out the possibility that the pathogen or the like 114a which may remain after cleaning and disinfection gets mixed into the pathogen or the like 114b when subjected to an experiment.

After the experiment on the pathogen or the like 114b finishes, clean and disinfect the surfaces of the work space 106 including the working surface 107a, so that an experiment on a pathogen or the like 114a can be carried out on the working surface 107a nearer to the rear air inlet 109.

When, for example, a fungus and a bacterium are handled with a single conventional safety cabinet 100, if the fungus should remain inside the work space 106, it has to be considered that the bacterium that is subsequently subjected to an experiment is contaminated because of active fertility of the fungus and scattering of its spores among others. As countermeasures, a conceivable way is to handle fungi and bacteria by different equipment units of safety cabinets 100, i.e., prepare different safety cabinets 100 for different characteristics of pathogens or the like 114; but, in some cases, it is not feasible to have safety cabinets 100 for each of kinds of pathogens or the like 114. In such a case, by handling the pathogen or the like 114a and the pathogen or the like 114b in different portions of the working surface 107a as in Example 1, in case the pathogen or the like 114 should remain, the working surface is partitioned by the work table air inlet 110 and, therefore, it is prevented by a drawn-in airflow 116 that two pathogens or the like 114 on the working surface 107a get mixed with one another.

The work table air inlet 110, the rear air inlet 109, and the work table front air inlet 108 are formed in rows in a lateral direction of the work space 106 of the safety cabinet 100. Therefore, the drawn-in airflow 116, the influent airflow 115, and a drawn-in airflow into the rear air inlet 109 which are generated are uniform in the lateral direction of the work space 106 and this minimizes the amount of movement of air in the lateral direction inside the work space 106. Minimizing the movement of air in the lateral direction rules out the possibility that a pathogen or the like 114 attaches to experimental tools arranged on either side of the pathogen or the like 114 placed for an experiment and the possibility that germs attached to the tools have an effect on the experiment.

In the work space 106 of a conventional safety cabinet 100, blown out clean air 102 are drawn in by the rear air inlet 109 and the work table front air inlet 108; consequently, even when the blowing wind velocity of clean air 102 is set to make a uniform wind velocity distribution, the wind velocity becomes faster in the rear and front portions above the working surface 107a where an experiment operation is performed and the wind velocity in the vicinity of the central row where separate forward and rearward airflows arise becomes slower, as the wind comes nearer to the working surface 107a. When a stagnating airflow at a low wind velocity is present, a pathogen or the like 114, if having entered the stagnant space, may float in the stagnant space and move into the working area at an unexpected time. In Example 1, the drawn-in airflow 116 is allowed to be generated in a location where the airflow stagnates in the vicinity of the central row in the work space 106 in the conventional safety cabinet 100. This drawn-in airflow 116 clears the space where the airflow stagnates. There arise portions where the airflow stagnates in the vicinity of airflow branch points between the drawn-in airflow 116 and a drawn-in airflow by the rear air inlet 109 and between the drawn-in airflow 116 and an drawn-in air by the work table front air inlet 108, but these portions are smaller in scope than the stagnant space in the conventional safety cabinet 100 a smaller range and there is less possibility that dust enters the stagnant portions. If the working surface 107a is made such that openings are provided to draw in air above all portions of the working surface 107a, portions where the airflow stagnates are eliminated, but this entails disadvantages that operability deteriorates because these openings are present and that airflow change occurs whenever an operating method changes for placing an object on the working surface 107a.

In Example 1, although the work table air inlet 110 is formed in the work table 107 to generate the drawn-in airflow 116, the influent airflow 115 is kept constant, because the amount of air moving in and out of the safety cabinet 100 is unchanged. As described in the foregoing context, it is enabled to separate the working surface 107a into certain regions, while maintaining the isolation performance of the safety cabinet 100.

### Example 2

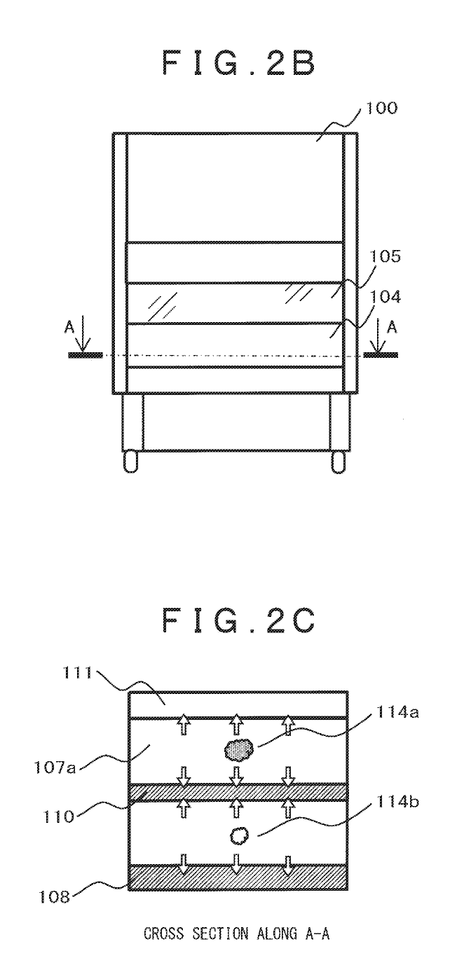

FIG. 2A is a cross-sectional structure diagram depicting a safety cabinet of Example 2, FIG. 2B is an external front view depicting the safety cabinet of Example 2, and FIG. 2C is a plan view of a work table (a cross-sectional view along line A-A in FIG. 2B) depicting the safety cabinet of Example 2.

Although the work table air inlet 110 is provided as an opening on a planar plane of the working surface 107a, if the opening and the working surface 107a are on the same plane, there is a possibility that the opening of the work table air inlet 110 is closed by an object and the drawn-in airflow 160 is not generated. Also, there is a danger that a small object falls through the work table air inlet 110. In Example 2, a projecting edged air inlet 117 is provided in the working surface 107a. The projecting edged air inlet 117 has a structure such that the edge of the work table air inlet is made to project into the work space 106. By providing the projecting edged air inlet 117, it is prevented that an object is placed on the projecting edged air inlet 117 and it can be prevented that the drawn-in airflow 116 is not generated. Also, it can be prevented that an object falls through the air inlet. The airflow arrangement, advantageous effects, and the method for usage are the same as in Example 1.

### Example 3

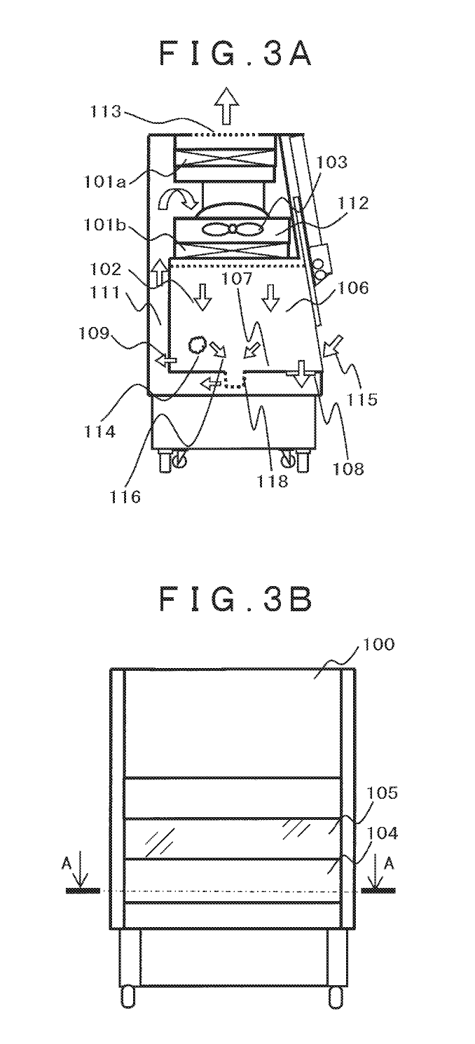

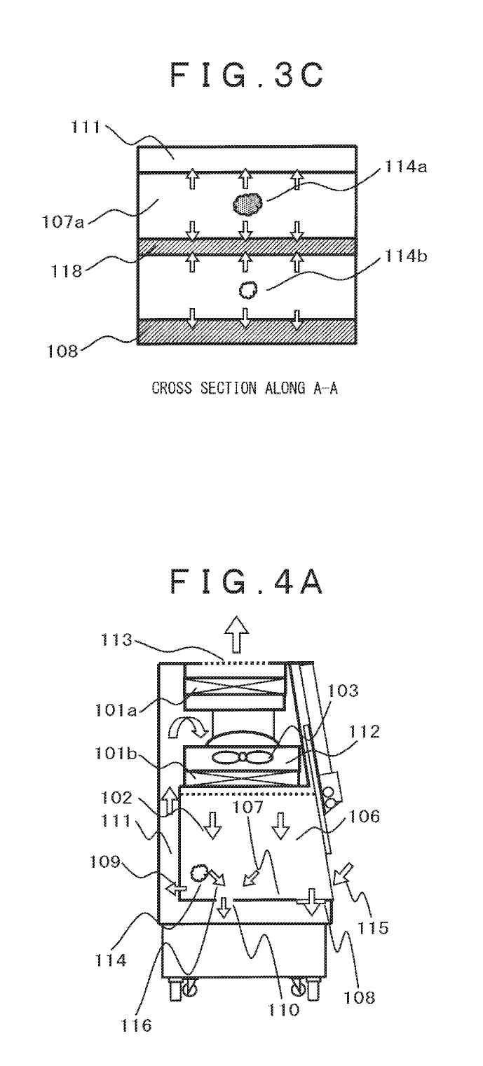

FIG. 3A is a cross-sectional structure diagram depicting a safety cabinet of Example 3, FIG. 3B is an external front view depicting the safety cabinet of Example 3, and FIG. 3C is a plan view of a work table (a cross-sectional view along line A-A in FIG. 3B) depicting the safety cabinet of Example 3.

In Example 3, the work table air inlet 110 in Example 1 is configured as a recessed air inlet 118 in a lateral direction of the working surface 107a, having a recessed intake part perforated like a wire mesh. By providing the work table air inlet with the perforated, recessed intake part, an object, if falling, is caught by the recess and can be prevented from falling under the working surface 107a. The airflow arrangement, advantageous effects, and the method for usage are the same as in Example 1.

### Example 4

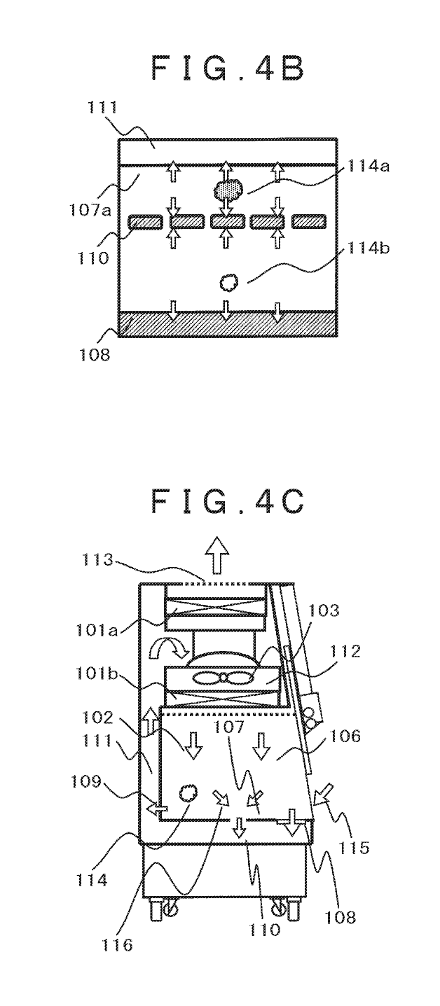

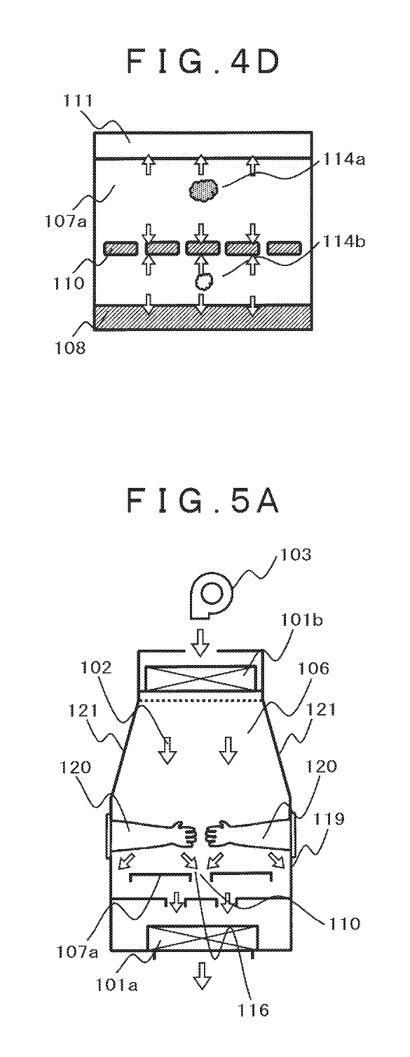

FIG. 4A is a cross-sectional structure diagram depicting a safety cabinet of Example 4 and FIG. 4B is one example of a plan view of a work table, depicting the safety cabinet of Example 4. Also, FIG. 4C is a cross-sectional structure diagram depicting the safety cabinet of Example 4 and FIG. 4D is a modification example of the plan view of the work table, depicting the safety cabinet of Example 4.

First, in FIG. 4A and FIG. 4B, the work table air inlet 110 is formed in a position nearer to the rear air inlet 109 with respect to the center of the working surface 107a. The work table 107 is configured as a single plate and the work table air inlet 110 is formed of a plurality of holes arranged in a row. A way of carrying out experiments on a pathogen or the like 114a and a pathogen or the like 114b is the same as in Example 1. In FIG. 4B, an experimental space for a pathogen or the like 114a is narrower than an experimental space for a pathogen or the like 114b.

Next, in FIG. 4C and FIG. 4D, the work table air inlet 110 is formed in a position nearer to the work table front air inlet 108 with respect to the center. This makes the experimental space for a pathogen or the like 114a wider than the experimental space for a pathogen or the like 114b. The airflow arrangement, advantageous effects, and the method for usage are the same as in Example 1.

To replace the configuration of FIG. 4A and FIG. 4B with the configuration of FIG. 4C and FIG. 4D and vice versa, the work table 107 configured as a single plate should be rotated by 180 degrees so that its anteroposterior position will be reversed on the working surface.

When using the safety cabinet, an experimental method may differ depending on the kind of pathogens or the like 114a, 114b to be treated. In Example 4, it is enabled to choose the largeness of a region on the working surface 107a according to combination of different experimental requirements.

### Example 5

Example 5 is an embodiment in which the present invention is applied to an isolator (grove box).

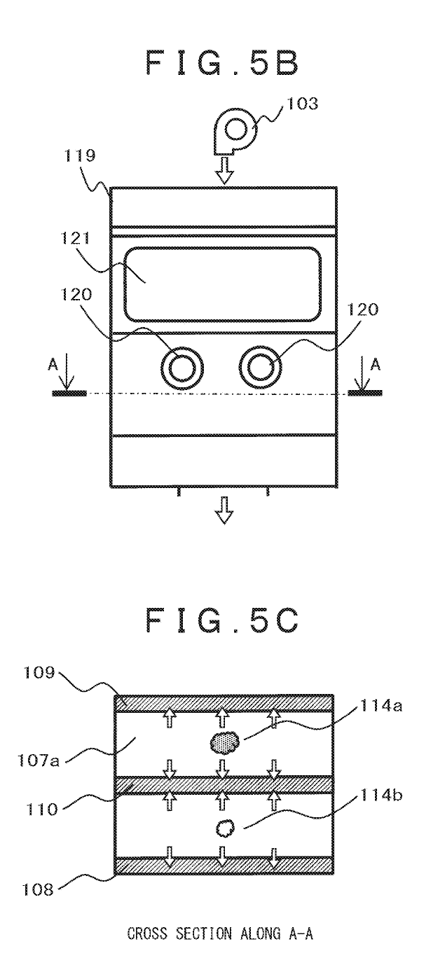

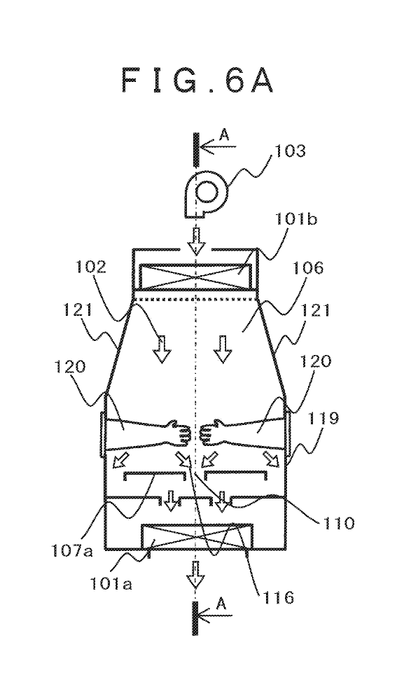

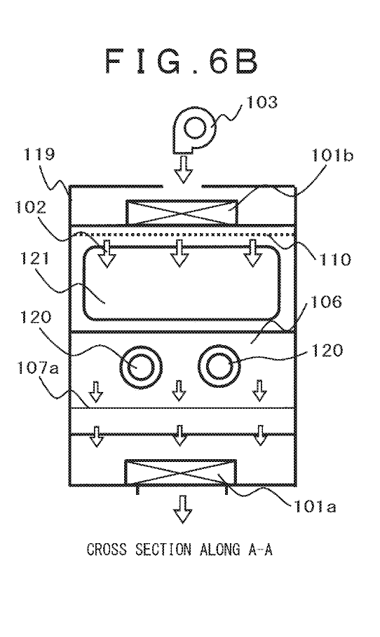

FIG. 5A depicts a cross-sectional structure diagram of an isolator of Example 5, FIG. 5B depicts an external front view of the isolator of Example 5, and FIG. 5C is a plan view of a work table (a cross-sectional view along line A-A in FIG. 5B) depicting the isolator of Example 5. Additionally, to represent airflow states, FIG. 6A depicts a side cross-sectional structure diagram of the isolator of Example 5 and FIG. 6B depicts a cross-sectional front view (a cross-sectional view along line A-A in FIG. 6A) of the isolator of Example 5.

Air blown by the air blower 103 is filtered by the blowing HEPA filter 101b to filter out dust and supplied as clean air 102 to the work space 106. The operator caries out an experiment, while viewing the inside of the work space 106 through observation windows 121. The operator carries out an experiment, inserting his or her hands into the work space through gloves 120. By this configuration, an experiment is performed with the inside of the work space 106 being isolated from outside. Although gloves are provided in the right and left sides (in the front and the rear of the isolator) in FIG. 5A, they may be provided in one side.

Air above the working surface 107a is drawn into intake holes formed adjacent to both observation windows 121 and the work table air inlet 110 formed in the center, filtered by the exhaust HEPA filter 101a to filter out a pathogen or the like 114 included in an experimental material, and discharged out of the isolator (glove box) 119 as clean air.

When changing a pathogen or the like to be handled inside the isolator (glove box) 119, it is required to sterilize and disinfect the inside once the inside to avoid that a pathogen or the like 114 to be subsequently treated is contaminated. In Example 5, the work table air inlet 110 is provided in the working surface 107a and air flowing right and air flowing in left (in the front and the rear of the isolator) in FIG. 5A are blocked by the drawn-in airflow 116; thus, a pathogen or the like which is treated in a right region will not move into a left region and a pathogen or the like 114 which is treated in the left region will not move into the right region and, therefore, it is enabled to reduce the number of times of sterilization and disinfection inside the isolator to be performed each time the isolator is used. To realize this, as the airflow arrangement for the isolator, it is prerequisite that airflows are uniform in a horizontal direction of the isolator (glove box) 119 and a disturbed flow does not arise, as depicted in FIG. 6A and FIG. 6B and, therefore, the observation windows 121 and the work table air inlet 110 are parallel in position. The airflow arrangement for experiments that are performed separately in the right and left regions of the work space 106 (in the front and the rear of the isolator) in FIG. 5A, advantageous effects, and the method for usage are the same as in Example 1.

### REFERENCE SIGNS LIST

100 . . . safety cabinet,
101a . . . exhaust HEPA filter,
101b . . . blowing HEPA filter,
102 . . . clean air,
103 . . . air blower,
104 . . . work opening,
105 . . . front shutter,
106 . . . work space,
107 . . . work table,
107a . . . working surface,
108 . . . work table front air inlet,
109 . . . rear air inlet,
110 . . . work table air inlet,
111 . . . rear flow path,
112 . . . pressure chamber,
113 . . . exhaust outlet,
114 . . . pathogen or the like,
115 . . . influent airflow,
116 . . . drawn-in airflow,
117 . . . projecting edged air inlet,
118 . . . recessed air inlet,
119 . . . isolator,
120 . . . gloves,
121 . . . observation window

1. A safety cabinet having a work opening in a front side of a work space and supplying clean air to the work space from above, the safety cabinet comprising:
a rear air inlet formed in a rear lower part of or at bottom rear side of the work space;
a front air inlet formed at bottom front side of the work space; and
a work table air inlet formed in a working surface between the rear air inlet and the front air inlet and in parallel to the front air inlet and/or the rear air inlet.

2. The safety cabinet according to claim 1, wherein the work table air inlet is formed in an intermediate position between the rear air inlet and the front air inlet.

3. The safety cabinet according to claim 1, wherein the work table air inlet is formed in parallel to a surface that an operator faces toward.

4. The safety cabinet according to claim 1, wherein the work table air inlet is a projecting edged air inlet whose edge is made to project into the work space.

5. The safety cabinet according to claim 1, wherein the work table air inlet includes a perforated, recessed intake part.

6. The safety cabinet according to claim 1, wherein the work table air inlet is formed nearer to the rear air inlet than an intermediate point between the rear air inlet and the front air inlet.

7. The safety cabinet according to claim 1, wherein the work table air inlet is formed nearer to the front air inlet than an intermediate point between the rear air inlet and the front air inlet.

8. The safety cabinet according to claim 1, comprising a work table formed of a single plate,
wherein the work table is provided with the work table air inlet that is formed in a forward or rearward offset position than an intermediate point between its forward and rear edges; and
the work table can be installed to allow its forward and rear edges to be reversed by being rotated by 180 degrees on the working surface.

9. An isolator having a glove or gloves in one side or both sides of surfaces to face each other of a work space and supplying clean air to the work space from above, the isolator comprising:
a working surface formed at a bottom of the work space;
intake holes formed on both sides of the working surface; and
an air inlet formed in the working surface between the intake holes on the both sides and in parallel to the intake holes.

10. The isolator according to claim 9, wherein the air inlet is positioned in the center of the working surface.
